(19) United States
(12) Patent Application Publication
(10) Pub. No.: US 2022/0402794 A1
(43) Pub. Date: Dec. 22, 2022

(54) PFAS TREATMENT SCHEME USING SEPARATION AND ELECTROCHEMICAL ELIMINATION

(71) Applicant: Evoqua Water Technologies LLC, Pittsburgh, PA (US)

(72) Inventors: YANG CHEN, Lowll, MA (US); SIMON P. DUKES, Chelmsford, MA (US); ADRIAAN JEREMIASSE, Bersingal (NL); WENXIN DU, Dover, NH (US); SAVVAS E. HADJIKYRIACOU, tyngsboro, MA (US); THOMAS K. MALLMANN, Rockford, IL (US)

(73) Assignee: Evoqua Water Technologies LLC, Pittsburgh, PA (US)

(21) Appl. No.: 17/617,300

(22) PCT Filed: Jan. 8, 2020
(86) PCT No.: PCT/US2020/012648

§ 371 Date: Dec. 7, 2021

Related U.S. Application Data
(60) Provisional application No. 62/858,401, filed on Jun. 7, 2019.

(51) Int. Cl. C02F 9/00; C02F 1/00

(52) U.S. Cl. CPC C02F 9/00; C02F 1/008; C02F 2101/36

(57) ABSTRACT

A system for treating a source of water contaminated with PFAS is disclosed. The system includes a PFAS separation stage having an inlet fluidly connectable to the source of water contaminated with PFAS, a diluate outlet, and a concentrate outlet and a PFAS elimination stage positioned downstream of the PFAS separation stage and having an inlet fluidly connected to an outlet of the PFAS separation stage, the elimination of the PFAS occurring onsite with respect to the source of water contaminated with PFAS, with the system maintaining an elimination rate of PFAS greater than about 99%. A method of treating water contaminated with PFAS is also disclosed. The method includes introducing contaminated water from a source of water contaminated with a first concentration of PFAS to an inlet of a

PFAS separation stage, treating the contaminated water in the PFAS separation stage to produce a product water substantially free of PFAS and a PFAS concentrate having a second PFAS concentration greater than the first PFAS concentration, introducing the PFAS concentrate to an inlet of a PFAS elimination stage; and activating the PFAS elimination stage to eliminate the PFAS in the PFAS concentrate. A method of retrofitting a water treatment system as described herein is also disclosed. The method includes providing a PFAS elimination module as described herein and fluidly connecting the PFAS elimination module downstream of a PFAS separation stage.

### CROSS-REFERENCE TO RELATED APPLICATIONS

This application claims priority under 35 U.S.C. § 119(e) to U.S. Provisional Patent Application Ser. No. 62/858,401 titled “PFAS Treatment Scheme Using Ion Exchange and Electrochemical Advanced Oxidation” filed Jun. 7, 2019, the entire disclosure of which is hereby incorporated herein by reference in its entirety for all purposes.

### FIELD OF TECHNOLOGY

Aspects and embodiments disclosed herein are generally related to the field of the removal and elimination of perfluoro alkyl substances (PFAS) from water.

### BACKGROUND

There is rising concern about the presence of various contaminants in municipal wastewater, surface water, drinking water, and groundwater. For example, perchlorate ions in water are of concern, as well as PFAS and PFAS precursors, along with a general concern with respect to total organic carbon (TOC).

PFAS are organic compounds consisting of fluorine, carbon and heteroatoms such as oxygen, nitrogen and sulfur. The hydrophobicity of fluorocarbons and extreme electronegativity of fluorine give these and similar compounds unusual properties. Initially, many of these compounds were used as gases in the fabrication of integrated circuits. The ozone destroying properties of these molecules restricted their use and resulted in methods to prevent their release into the atmosphere. But other PFAS such as fluoro-surfactants have become increasingly popular. PFAS are commonly use as surface treatment/coatings in consumer products such as carpets, upholstery, stain resistant apparel, cookware, paper, packaging, and the like, and may also be found in chemicals used for chemical plating, electrolytes, lubricants, and the like, which may eventually end up in the water supply. Further, PFAS have been utilized as key ingredients in aqueous film forming foams (AFFFs). AFFFs have been the product of choice for firefighting at military and municipal fire training sites around the world. AFFFs have also been used extensively at oil and gas refineries for both fire training and firefighting exercises. AFFFs work by blanketing spilled oil/fuel, cooling the surface, and preventing re-ignition. PFAS in AFFFs have contaminated the groundwater at many of these sites and refineries, including more than 100 U.S. Air Force sites.

Although used in relatively small amounts, these compounds are readily released into the environment where their extreme hydrophobicity as well as negligible rates of natural decomposition results in environmental persistence and bioaccumulation. It appears as if even low levels of bioaccumulation may lead to serious health consequences for contaminated animals such as human beings, the young being especially susceptible. The environmental effects of these compounds on plants and microbes are as yet largely unknown. Nevertheless, serious efforts to limit the environmental release of PFAS are now commencing.

### SUMMARY

In accordance with an aspect, there is provided an onsite system for treating a source of water contaminated with PFAS. The onsite system may comprise a PFAS separation stage having an inlet fluidly connectable to the source of water contaminated with PFAS, a diluate outlet, and a concentrate outlet and a PFAS elimination stage positioned downstream of the PFAS separation stage having an inlet fluidly connected to an outlet of the PFAS separation stage. The elimination of PFAS with the system may occur onsite with respect to the source of water contaminated with PFAS. The system may be configured to maintain an overall elimination rate of PFAS greater than about 99%.

In some embodiments, the system maintains a concentration of PFAS in the diluate of the PFAS separation stage below a predetermined threshold. For example, the predetermined threshold may be less than the 70 parts per trillion (ppt) U.S. EPA combined lifetime exposure maximum standard. In particular embodiments, the predetermined threshold is less than 12 ppt.

In further embodiments, the system comprises a hardness removal stage. In some embodiments, the system includes a control system configured to regulate the feed directed between the PFAS separation stage and the PFAS elimination stage. In some embodiments, the system comprises a PFAS sensor positioned downstream of the diluate outlet of the PFAS separation stage.

In certain embodiments, the PFAS separation stage comprises one or more ion exchange modules. The ion exchange modules may be regenerated to remove bound PFAS to produce a PFAS concentrate. In some embodiments, the regeneration comprises contacting the ion exchange modules with a regeneration solution comprising methanol, water, and NaOH.

In some embodiments, the PFAS separation stage comprises one or more nanofiltration modules. A concentrate comprising PFAS from the one or more nanofiltration modules may have its PFAS concentration increased by passing through one or more nanofiltration diafiltration modules downstream of the one or more nanofiltration modules. In some cases, the one or more nanofiltration diafiltration modules target removal of NaCl and/or KCl.

In some embodiments, the PFAS separation stage involves adsorption onto an electrochemically active substrate. The electrochemically active substrate may comprise granular activated carbon (GAC). The GAC may be incorporated into an electrode in an electrochemical cell. In some embodiments, an electrode in the electrochemical cell comprises platinum, a mixed metal oxide (MMO) coated dimensionally stable anode (DSA) material, graphite, or lead/lead oxide. In further embodiments, the electrochemical cell comprises a sulfate electrolyte. In certain embodiments, the electrochemical cell comprises an ion exchange membrane separator. PFAS that are adsorbed to the electrochemically active substrate may be desorbed by electrical activation of the electrochemical cell.

In some embodiments, the PFAS separation stage involves foam fractionation.

In some embodiments, the PFAS elimination stage comprises an electrochemical PFAS elimination stage. For example, the electrochemical PFAS elimination stage may comprise an electro-advanced oxidation system, such as an electrochemical cell.

In some embodiments, the electrochemical cell involves a boron doped diamond (BDD) electrode.

In particular embodiments, the electrochemical cell involves a Magneli phase titanium oxide electrode, in particular a Tiₙ, O₂ₙ₋₁(n=4-10) electrode. An exemplary electrode is Ti₄O7.

In some embodiments, an electrode of the electrochemical cell is made of a stainless steel, nickel alloy, titanium, or a DSA material. In some embodiments, the electrochemical cell comprises an electrolyte comprising at least one of hydroxide, sulfate, nitrate, and perchlorate.

In some embodiments, the PFAS elimination stage comprises an advanced oxidation process (AOP) reactor. For example, the AOP may involve a UV-persulfate treatment or a plasma treatment.

In accordance with an aspect, there is provided a method of treating water contaminated with PFAS. The method may comprise introducing contaminated water from a source of water contaminated with a first concentration of PFAS to an inlet of a PFAS separation stage. The method may further comprise treating the contaminated water in the PFAS separation stage to produce a product water substantially free of PFAS and a PFAS concentrate having a second PFAS concentration greater than the first PFAS concentration. The method may additionally comprise introducing the PFAS concentrate to an inlet of a PFAS elimination stage and activating the PFAS elimination stage to eliminate the PFAS in the PFAS concentrate. The method may have a PFAS elimination rate greater than about 99%.

In some embodiments, the elimination of PFAS occurs onsite with respect to the source of contaminated water.

In further embodiments, the method may comprise treating the PFAS concentrate from the PFAS separation stage to produce a concentrate having a third concentration of PFAS. The third PFAS concentration may be greater than the second PFAS concentration. The concentrate having the third concentration of PFAS may be introduced to the inlet of the PFAS elimination stage.

In some embodiments, the method may further comprise monitoring a pressure, temperature, pH, concentration, flow rate, or TOC) level in the source water and/or product water.

In certain embodiments, the PFAS separation stage comprises one or more ion exchange modules. In some embodiments, the PFAS separation stage comprises one or more nanofiltration modules. In some embodiments, the PFAS separation stage involves adsorption onto an electrochemically active substrate. In some embodiments, the PFAS separation stage involves foam fractionation.

In some embodiments, the PFAS elimination stage comprises an electrochemical PFAS elimination stage. For example, the electrochemical PFAS elimination stage may comprise an electro-advanced oxidation system, such as an electrochemical cell.

In some embodiments, the electrochemical cell involves a BDD electrode.

In particular embodiments, the electrochemical cell involves a Magneli phase titanium oxide electrode.

In some embodiments, the electrochemical cell comprises an electrolyte comprising at least one of hydroxide, sulfate, nitrate, and perchlorate.

In some embodiments, the PFAS elimination stage comprises an AOP reactor. For example, the AOP may involve a UV-persulfate treatment or a plasma treatment.

In accordance with another aspect, there is provided a method of retrofitting a water treatment system. The method may comprise providing a PFAS elimination stage and fluidly connecting the PFAS elimination stage downstream of a PFAS separation stage.

In some embodiments, the PFAS elimination stage comprises an electrochemical PFAS elimination stage. For example, the electrochemical PFAS elimination stage may comprise an electro-advanced oxidation system, such as an electrochemical cell.

In some embodiments, the electrochemical cell involves a BDD electrode.

In particular embodiments, the electrochemical cell involves a Magneli phase titanium oxide electrode.

In some embodiments, the PFAS elimination stage comprises an AOP reactor. For example, the AOP may involve a UV-persulfate treatment or a plasma treatment.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a flow diagram of a PFAS treatment system where recovered water from the elimination of PFAS is collected as treated water. Inset tables provide modeled concentrations of various components of the water stream at specific locations in the system.

FIG. 2 is a flow diagram of a PFAS treatment system where recovered water from the elimination of PFAS is used as makeup water for the feed to the PFAS separation stage. Inset tables provide modeled concentrations of various components of the water stream at specific locations in the system.

FIG. 3 is a flow diagram of a PFAS treatment system configured to remove higher concentrations of partially oxidized PFAS.

FIG. 4 is a flow diagram of a PFAS treatment system where nanofiltration is used as the PFAS separation stage.

FIG. 5 is a flow diagram of a PFAS treatment system where nanofiltration is used as the PFAS separation stage. Inset tables provide modeled concentrations of various components of the water stream at specific locations in the system.

FIG. 6 is a flow diagram of a method of separating PFAS from a source of water using adsorption onto a GAC electrode and desorption of PFAS from the GAC electrode in an electrochemical cell.

FIG. 7 is a sequence of the reactions taking place at the surface of an electrode during electrochemical elimination of PFAS.

FIG. 8 is a scatter plot showing the length of time needed to decrease both the total PFAS concentration and the concentration of the species PFOS without a concentrating separated PFAS from a source of water.

### DETAILED DESCRIPTION

In accordance with one or more embodiments, systems and methods disclosed herein relate to the separation, concentration, and elimination of PFAS from a source of water that is contaminated with PFAS. These man-made chemical compounds are very stable and resilient to breakdown in the environment. They may also be highly water soluble because they carry a negative charge when dissolved. They were developed and widely used as a repellant and protective coating. Though some PFAS compounds have now largely been phased out, elevated levels are still widespread. For example, water contaminated with PFAS may be found in industrial communities where they were manufactured or used, as well as near airfields or military bases where firefighting drills were conducted. PFAS may also be found in remote locations via water or air migration. Many municipal water systems are undergoing aggressive testing and treatment. This invention is not limited to the types of negatively charged and/or fluorinated compounds being treated.

In some specific non-limiting embodiments, common PFAS such as perfluorooctanoic acid (PFOA) and/or perfluorooctane sulfonic acid (PFOS) may be removed from water. The U.S. Environmental Protection Agency (EPA) developed revised guidelines in May 2016 of a combined lifetime exposure of 70 parts per trillion (ppt) for PFOS and PFOA. Federal, state, and/or private bodies may also issue relevant regulations. For example, the state of New Hampshire has adopted groundwater Maximum Contaminant Levels (MCLs) of 12 ppt for PFOA, 15 ppt for PFOS, 18 ppt for perfluorohexane sulfonic acid (PFHxS), and 11 ppt for perfluoro nonanoic acid (PFNA). In some cases, the systems described herein can maintain a concentration of PFAS in treated water to be below the regulated levels.

In accordance with one or more embodiments, PFAS may be separated from a process stream in order to provide a concentrated PFAS stream for enhanced PFAS conversion or destruction. Concentration of the PFAS stream reduces the energy consumption necessary to destroy PFAS via known methods, such as electrochemical or photochemical oxidation.

A system of the present invention includes a PFAS separation stage having an inlet fluidly connectable to the source of water contaminated with PFAS, a diluate outlet, a concentrate outlet, and a PFAS elimination stage positioned downstream of the PFAS separation stage and having an inlet fluidly connected to an outlet of the PFAS separation stage. During treatment, a source of water contaminated with PFAS is introduced to the inlet of the PFAS separation stage. The PFAS are separated from the water, producing a concentrate enriched in PFAS and a diluate that can be discharged for its intended purpose, such as for potable water or irrigation water. Systems of the invention can maintain a concentration of PFAS in the diluate of the PFAS separation stage below a predetermined threshold, such as a Federal, state, or private agency standard. Systems of the present invention are advantageous in that the separation of PFAS from the source of contaminated water and the elimination of the separated PFAS occur onsite with respect to the source of water. Typically, separated PFAS are concentrated and then transported to a separate facility for elimination, which is both dangerous and expensive. Further, the elimination of PFAS produces recoverable F⁻ ions and HF, both of which are useful for industrial processes, such as glass etching, metal cleaning, and in electronics manufacturing.

### PFAS Separation

PFAS, as a class of compounds, are very difficult to treat largely because they are extremely stable compounds which include carbon-fluorine bonds. Carbon-fluorine bonds are the strongest known single bonds in nature and are highly resistant to breakdown. PFAS may be removed from a source of contaminated water by a number of known mechanisms with varying degrees of success. Conventional activated carbon adsorption systems and methods to remove PFAS from water have shown to be effective on the longer alkyl chain PFAS but have reduced bed lives when treating shorter alkyl chain compounds. Some conventional anion exchange resins have shown to be effective on the longer alkyl chain PFAS but have reduced bed lives when treating shorter alkyl chain compounds.

### Ion Exchange

In some embodiments, separation of PFAS from a source of contaminated water may be achieved using an ion exchange process, such as cation exchange or anion exchange. Conventional anion exchange treatment systems and methods typically utilize anion exchange resin where positively charged anion exchange resin beads are disposed in a lead vessel which receives a flow of water contaminated with anionic contaminants, such as PFAS. The negatively charged contaminants are trapped by the positively charged resin beads and clean water flows out of the lead anion exchange vessel into a lag vessel, also containing anion exchange resin beads. A sample tap is frequently used to determine when the majority of the anion exchange beads in the lead exchange vessel have become saturated with contaminants. When saturation of the resin anion exchange beads is approached, a level of contaminants will be detected in the effluent tap. When this happens, the lead vessel is taken off-line, and the contaminated water continues flowing to the lag vessel which now becomes the lead vessel. The lead-lag vessel configuration ensures that a high level of treatment is maintained at all times.

As discussed above, some conventional anion exchange resins can also be used to remove PFAS from water. A number of known methods exist to regenerate the anion exchange beads in the anion exchange vessel. Some known methods rely on flushing the resin with a brine or caustic solution. Other known methods may include the addition of solvents, such as methanol or ethanol, to enhance the removal of the PFAS trapped on the anion exchange beads. Effective resin regeneration has been demonstrated by passing a solvent (such as methanol or ethanol), blended with a solution containing sodium chloride, sodium hydroxide, or another salt, through the resin. However, such methods may generate a large amount of toxic regenerant solution which must be disposed of at significant expense. There is also a need to further treat the waste regenerant solution to concentrate the PFAS and reduce the volume of waste. This is a key step, because resin regeneration produces a significant volume of toxic waste.

In accordance with one or more embodiments, the PFAS separation stage includes an ion exchange vessel having a selected ion exchange resin, such as an anion exchange resin, to remove PFAS from the water. A source of water contaminated with PFAS is introduced to an inlet of the PFAS separation stage with ion exchange such that the PFAS binds to the selected anion exchange resin and are removed from the water. A regeneration solution is periodically used to remove the PFAS from the anion exchange resin, thereby regenerating the anion exchange resin and generating a spent regeneration solution comprised of the removed PFAS and a regeneration solution. The PFAS concentration of the regeneration solution may be increased by removing liquid volume from the regeneration solution to allow partial reuse of the regeneration solution. The remaining solution, having an enriched concentration of PFAS, may be further treated for PFAS elimination using a PFAS elimination stage.

Regeneration solutions comprising a salt solution and an alcohol have been demonstrated to be effective in regenerating the anion exchange resin. The anion systems used in these regeneration chemistries can be chosen from, for example, Cl⁻, OH⁻, SO₄²⁻, and NO₃⁻, among others. While all of these ions effective in regenerating an ion exchange resin, there is a difference in efficiency of removal. To balance this efficiency of removal, there is also a knock-on effect of anion choice on the PFAS elimination stage. For example, chloride ion solutions are frequently used for ion exchange regeneration, but have implications for an electrochemical PFAS elimination system, as the chloride ion would be preferentially be driven to hypochlorite or chlorate in an electrochemical cell, causing a significant increase in energy consumption and inefficiency for the oxidation of the PFAS. Further, some chloride will be oxidized to perchlorate, which is an environmentally persistent anion requiring further treatment. Sulfate ion solutions at the concentrations effective for regenerating the anion exchange resin have a depressing effect on the oxidation of the PFAS. Nitrate and hydroxide ion solutions are both suitable, however, comparing the MCL values, nitrate has a primary MCL of 10 ppm and hydroxide would have a potential problem with the overall solution pH.

Hydroxide solutions may be neutralized with sulfuric acid after oxidation, as the sulfate ion has a secondary MCL of 250 ppm. To make the regeneration effective for PFAS, a water-miscible solvent will be needed in the regeneration solution. As noted herein, alcohols are an example of useful solvents for this purpose, with methanol being an exemplary alcohol.

The chloride and sulfate concentrations in the regeneration solution may be substantially reduced by first stripping the regeneration solution with NaOH without methanol. It may be possible to get rid of greater than at least 95% of the other anions by first stripping the resin with NaOH. The spent NaOH fraction can then be neutralized and reused as makeup water for the source of contaminated water. Subsequent stripping with methanol and NaOH would remove the PFAS without other anions. In some cases, a second regeneration may be run using a lower NaOH concentration as the first regeneration stripped a substantial fraction of anions from the regeneration solution. The preparation of the PFAS concentrate solution without the burden of the associated anions will make subsequent treatment of the PFAS concentrate solution more efficient and effective.

Irrespective of the choice of anion system, the alcohol will need to be removed prior to the oxidation and to further concentrate the PFAS in the concentrate. Removal of the methanol from the PFAS concentrate is typically achieved thermally, such as with distillation. In accordance with some embodiments, removal of the methanol to concentrate the PFAS in solution may be achieved with solvent-resistant nanofiltration, diafiltration, or pervaporation. Other techniques for recovering the parts of a regeneration solution and increasing the concentration of PFAS dissolved therein are known in the art.

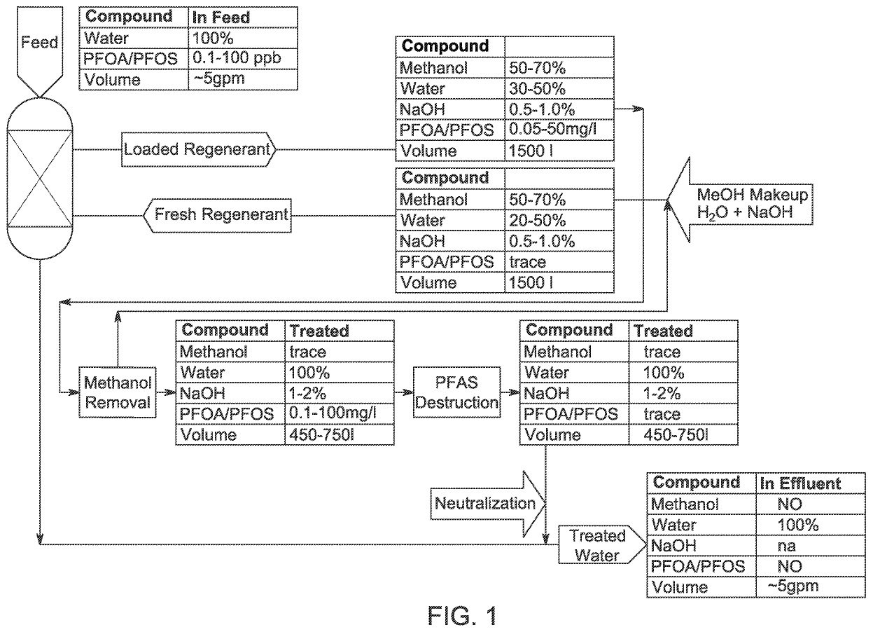

Systems for treating water using ion exchange to remove PFAS from water, regeneration solutions for desorbing the PFAS from the ion exchange resin and removing a portion of the regeneration solution to increase the concentration of PFAS in the remaining regeneration solution are shown in FIGS. 1-3.

### Filtration

In some embodiments, separation of PFAS from a source of contaminated water may be achieved using a physical separation process, such as filtration with a membrane. In such cases, the membranes comprise pores of a diameter sufficient to allow water to pass through but for the PFAS to be retained and collected. In accordance with one or more embodiments, the PFAS separation stage includes one or more solvent-resistant nanofiltration stages. The number of nanofiltration stages and the types of nanofiltration membranes utilized in a PFAS separation stage of the invention will depend on the matrix of the source of contaminated water. As an example, nanofiltration membranes are sensitive to high concentrations of total suspended solids (TSS), free chlorine, and certain heavy metals (such as Al, Mn, Fe, and Zn) in solution; thus, if the source of water contaminated with PFAS is also high in TSS, free chlorine and/or heavy metals, the excess TSS, chlorine, and/or heavy metals should be removed using a one or more pre-treatments prior to PFAS separation.

The permeate of the one or more stages of nanofiltration is substantially free of PFAS; the concentrate of the nanofiltration stages has an enriched concentration of PFAS. As described herein, the PFAS in the concentrate may have the concentration further enriched to reduce the energy consumption and increase the effectiveness of a later PFAS elimination stage. In some embodiments, the concentrate from the nanofiltration PFAS separation stage may be introduced to the inlet of a separate nanofiltration diafiltration stage to remove excess salts, such as NaCl or KCl, from the concentrate and further concentrate the PFAS in the concentrate solution that results from this step. The diluate from this step, made up with water from an external source of water having a low TSS content, may be used as make up water for the source of contaminated water.

In accordance with certain embodiments of a nanofiltration-based PFAS separation stage, systems of the present invention incorporating said nanofiltration may include a stage for hardness removal, such as by chemical precipitation. The inclusion of a hardness removal stage may be necessary if there is a concern for potential scaling or fouling of membranes or other downstream process equipment introduced by insoluble alkaline earth metal salts, such as calcium or magnesium sulfates, phosphates, and carbonates. The optional hardness removal stage may be configured to accept the PFAS enriched concentrate from the one or more nanofiltration PFAS separation stages.

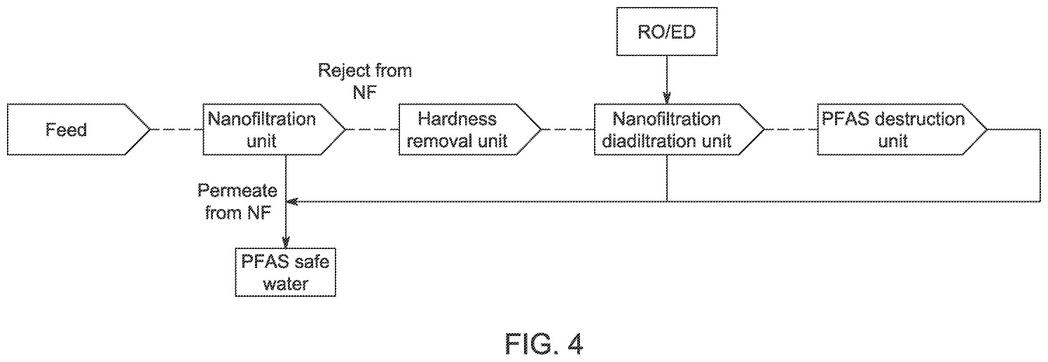

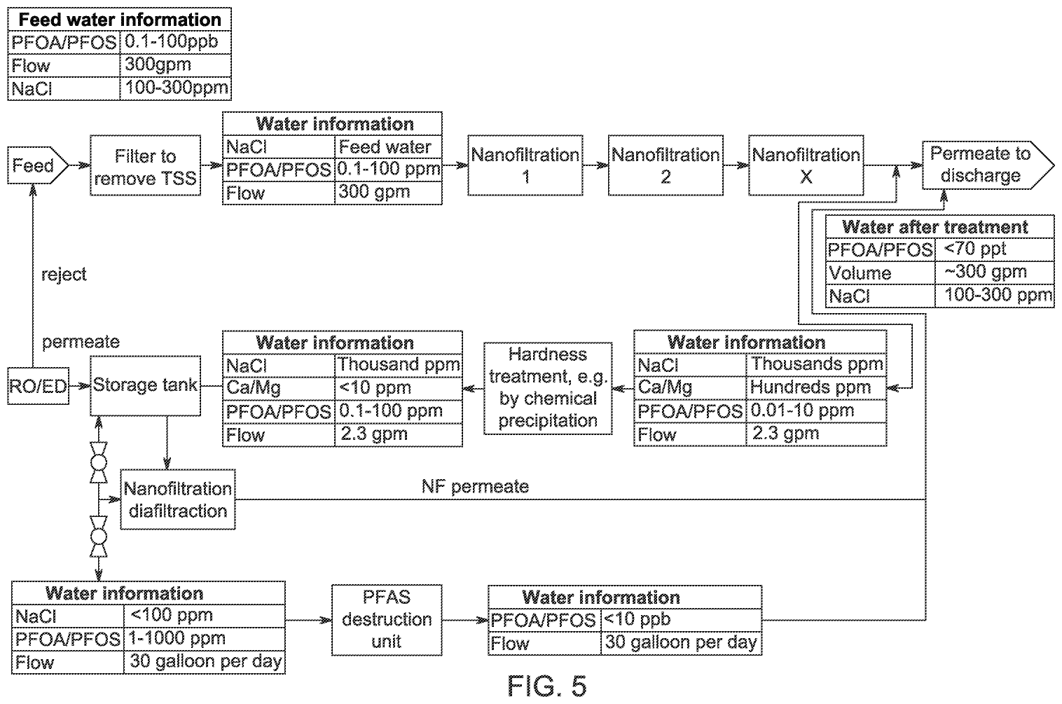

Systems for treating water using one or more nanofiltration stages to remove PFAS from water, removing hardness from the PFAS enriched concentrate from the nanofiltration stages, and using an additional stage of nanofiltration diafiltration to increase the concentration of PFAS in the remaining solution are shown in FIGS. 4 and 5.

### Adsorption

In some embodiments, separation of PFAS from a source of contaminated water may be achieved using an adsorption process, where the PFAS are physically captured in the pores of a porous material (i.e., physisorption) or have favorable chemical interactions with functionalities on a filtration medium (i.e., chemisorption). In accordance with one or more embodiments, the PFAS separation stage may include adsorption onto an electrochemically active substrate. An example of an electrochemically active substrate that can be used to adsorb PFAS is granular activated carbon (GAC). Adsorption onto GAC, compared to other PFAS separation methods, is a low-cost solution to remove PFAS from water that can potentially avoid known issues with other removal methods, such as the generation of large quantities of hazardous regeneration solutions of ion exchange vessels and the lower recovery rate and higher energy consumption of membrane-based separation methods such as nanofiltration and reverse osmosis (RO). Akin to ion exchange, GAC removes PFAS from a source of contaminated water by adsorption. However, employing GAC for a PFAS elimination stage is achievable by incineration at temperature higher than 600° C., which is highly energy and cost intensive

In some embodiments, the GAC used for adsorption removal of PFAS may be modified to enhance its ability to remove negatively charged species from water, such as deprotonated PFAS. For example, the GAC may be coated in a positively charged surfactant that preferentially interacts with the negatively charged PFAS in solution. The positively charged surfactant may be a quaternary ammonium-based surfactant, such as cetyltrimethylammonium chloride (CTAC). Activated carbons useful for the present invention and modifications that may be performed on said activated carbons are described in U.S. Pat. No. 8,932,984, U.S. Pat. No. 9,914,110, and PCT/US2019/046540, all to

Evoqua Water Technologies LLC, each of which hereby being incorporated herein by reference in its entirety for all purposes.

In the present invention, the adsorptive properties of GAC are advantageous for use as a component of an electrode in an electrochemical cell. The GAC electrode comprises GAC, conductors (such as graphite or carbon black), and suitable binders (e.g., polytetrafluoroethylene (PTFE) or polyvinylidene fluoride (PVDF)). When a GAC electrode is used in an electrochemical cell, the other electrode may be a chemically and electrochemically stable electrode, for example platinum, MMO-coated DSA material, graphite, Pb/PbO₂, among others known in the art. In particular embodiments, both the cathode and the anode of the electrochemical cell may be GAC electrodes if a cation exchange membrane is embedded in between both GAC electrodes.

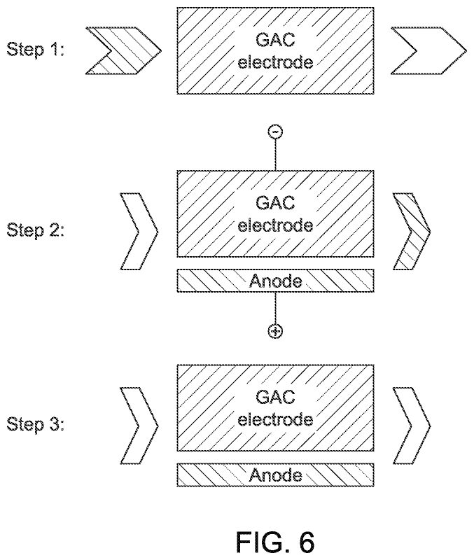

A general process of using a GAC electrode to reversibly adsorb and desorb PFAS from a source of contaminated water is shown in FIG. 6 and can broadly be described as a three-step process. In step 1, a source of water contaminated with PFAS is allowed to circulate around a GAC electrode, leaving PFAS adsorbed on the surface of the electrode. Step 1 may be run in a batch mode if the level of PFAS contamination in the source of water is high; alternatively, step 1 may be performed in a single pass if the level of PFAS contamination in the source of water is low. In step 2, a prepared synthetic water would be circulated through the electrochemical cell in which the cathode is the GAC electrode, and an ion exchange membrane may be embedded in between the electrodes. Activating the electrochemical cell, such as applying a voltage or reversing an applied current, allows the adsorbed PFAS on the GAC cathode to desorb and concentrate the synthetic water circulating in the electrochemical cell. A preferred mode of operation for step 2 is batch mode, and the concentrated PFAS aqueous solution will be collected for further elimination treatments. To reduce energy consumption, a salt (such as Na₂SO₄) may be added into the synthetic water circulating in the electrochemical cell to increase water conductivity. The amount of salt added to the synthetic water is dependent on the subsequent elimination step and discharge regulations as discussed herein. Step 3 is a potential balance step to zero charge of the GAC electrode to prevent any drop in PFAS removal efficiency due to double layer adsorption of cations on the GAC electrode. This step ensures that the GAC electrode recovered after PFAS desorption is both charge neutral and free of adsorbed salts. The desorbed PFAS from the GAC electrode may be further concentrated using methods described herein or introduced to a PFAS elimination stage.

### Foam Fractionation

In some embodiments, separation of PFAS from a source of contaminated water may be achieved using foam fractionation, where foam produced in a source of contaminated water rises and removes hydrophobic molecules from the water. Foam fractionation has typically been utilized in aquatic settings, such as aquariums, to remove dissolved proteins from the water. During foam fractionation, gas bubbles rise through a vessel of contaminated water, forming a foam that has a large surface area air-water interface with a high electrical charge. The charged groups on PFAS molecules adsorb to the bubbles of the foam and form a surface layer enriched in PFAS that can subsequently be removed. The bubbles may be formed using any suitable gas, such as compressed air or nitrogen. In some embodiments, the bubbles for form the foam are formed from an oxidizing gas, such as ozone. Foam fractionation system useful for the invention are known in the art.

### PFAS Elimination

Various techniques for treating the concentrated stream to effect PFAS conversion or destruction may be implemented. The elimination of PFAS from concentrated streams using the PFAS elimination methods described herein produces H⁺ and F⁻ ions in solution.

### Electrochemical

In accordance with one or more embodiments, a PFAS elimination stage may include an electrochemical PFAS elimination stage comprising an electro-advanced oxidation system. The electro-advanced oxidation system may comprise an electrochemical cell used to degrade PFAS in water. The electrochemical cell may generally include two electrodes, i.e., a cathode and an anode. A reference electrode may also be used, for example, in proximity to the anode.

In accordance with one or more embodiments, the cathode may be constructed of various materials. Environmental conditions, e.g., pH level, and specific process requirements, e.g., those pertaining to cleaning or maintenance, may impact cathode selection. In some non-limiting embodiments, the cathode may be made of stainless steel, nickel alloy, titanium, or a DSA material. DSA materials may be uncoated or may be coated with noble metals or metal oxides, such as Pt or IrO₂, among others.

In accordance with one or more embodiments, the anode may be constructed of a material characterized by a high oxygen evolution overpotential. Overpotential may generally relate to the potential difference (voltage) between a half-reaction's thermodynamically determined reduction potential and the potential at which a redox event is experimentally observed. The term may be directly related to an electrochemical cell's voltage efficiency.

In accordance with one or more embodiments, the anode may exhibit a preference for a surface reaction in water. Based on various physical characteristics and/or the chemical composition of the anode, water molecules may be repelled from the surface while non-polar organic pollutants may be easily absorbed. This may promote a direct oxidation reaction on the surface which may, for example, be particularly beneficial for the treatment of PFAS.

In accordance with one or more embodiments, the anode may be constructed of a Magnéli phase titanium oxide of the general formula TiₙO₂ₙ₋₁, where n=4-10 inclusive. Magnéli phase titanium oxide anodes may have superior performance for inhibiting oxygen evolution compared to other anode materials. This may allow for the direct oxidation of PFAS on its surface. Additionally, in comparison to other electrodes with similar overpotential characteristics, Magneli phase titanium oxide is less expensive than boron doped diamond (BDD), more robust than Ti/SnO₂, and more environmentally friendly than Pb/PbO₂. Magnéli phase electrodes and electrochemical cells comprising said electrodes for PFAS elimination are described in PCT/US2019/047922, the disclosure of which is herein incorporated by reference in its entirety for all purposes. In accordance with one or more embodiments, the anode may be constructed of BDD.

In accordance with one or more embodiments, the Magnéli phase titanium oxide anode or BDD anode may be used in an electrochemical cell. The anode may be formed in a variety of shapes, for example, planar or circular. In at least some preferred embodiments, the anode may be characterized by a mesh or foam structure, which may be associated with a higher active surface area, pore structure, and/or pore distribution.

The supporting electrolyte chosen for the electrochemical PFAS elimination may be chosen to minimize energy consumption for removing PFAS from the contaminated water. As shown in Table 1, electrolytes may include any of Cl⁻, SO₄²⁻, NO₃⁻, ClO₄⁻ and OH⁻ ions. The energy consumption data of Table 1 is presented as a range to show the spread of efficiency by employing different electrolytes in the source water based on the treatment of PFAS, in particular PFOA. Among the electrolytes of Table 1, both NO₃⁻ and ClO₄⁻ are effective for PFAS elimination but have significant environmental impact for disposal. Reduction of PFOA is possible by adopting a dilute concentration Cl⁻ solution as the supporting electrolyte; however, in practice, chlorination and oxygen evolution are the dominant reactions occurring on the electrode surfaces. These electrode surface reactions produce free chlorine, chlorate ions, and perchlorate ions in solution, which pose concerns as sources of secondary contamination. SO₄²⁻ electrolytes are effective at PFAS elimination and have low environmental impact; however, sulfates are only effective at low concentrations (less than 20 mM, preferably about 5mM of SO₄²⁻); this concentration range is insufficient for the ion exchange regeneration process. This result is also in agreement with literature which suggests that SO₄²⁻ electrolytes do not promote the electro-oxidative generation of OH·due to strong adsorption at the surfaces of the electrodes. NaOH represents a balanced choice among the common electrolytes even though the PFAS elimination efficiency of NaOH electrolytes is inversely dependent on the NaOH concentration.

TABLE 1
Effect of Electrolyte on Energy Consumption for PFOA Removal from
Contaminated Water Containing 10 ppm PFOA

| | Energy Consumption per ppm PFOA removal |
|---|---|
| Electrolyte | (kWh/m³/ppm) |
| 10 mM NaCl | 10-100 |
| 5000 ppm NaCl | >3000 |
| 5 mM Na₂SO₄ | 1-10 |
| 100 mM Na₂SO₄ | >1000 |
| 10 mM NaClO₄ | <1 |
| 10 mM NaOH | 1-10 |
| 5000 ppm NaOH | 10-100 |
| 5000 ppm NaNO₃ | 1-10 |

In operation, a process stream containing an elevated PFAS level may be introduced to an electrochemical cell for treatment. The electrochemical cell may include a Magnéli phase titanium oxide anode or a BDD anode as described herein. The anode material may have a porosity of at least about 25%. The anode material may have a mean pore size ranging from about 100 μm to about 2 mm The electrochemical cell may include an electrolyte as described herein and a voltage may be applied to the anode as described herein to provide a desired level of treatment. Various pre-treatment and/or post-treatment unit operations may also be integrated. A product stream may be directed to a further unit operation for additional treatment, sent to a point of use, or otherwise discharged. Polarity of the electrochemical cell may be reversed periodically if desired such as to facilitate maintenance.

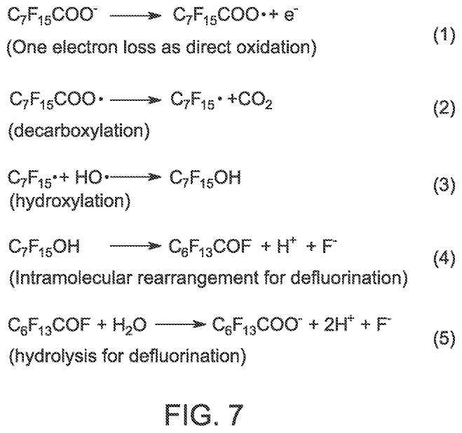

In accordance with one or more embodiments, Equations 1 through 5 shown in FIG. 7 may represent the underlying mechanism for electrochemical PFAS removal with a BDD or Magnéli phase titanium oxide (TiₙO₂ₙ₋₁) anode. The reaction may generally be characterized as a Kolbe-type oxidation. The reaction initiates from direct oxidation of carboxylate ions to carboxylate radicals (Eq. 1) on a the electrode surface by applying a sufficient positive voltage. The carboxylate radicals are subsequently decarboxylated to perfluoroalkyl radicals (Eq. 2). By coupling with hydroxyl free radicals which are anodically generated on the electrode surface, the perfluoroalkyl radicals are converted to perfluoro alcohols (Eq. 3) which further defluorinate to perfluoro carbonyl fluoride (Eq. 4) and finally hydrolyzed to a perfluorocarboxylic as a byproduct by losing one carbon in the chain (Eq. 5). Reactions 1 to 5 may generally be repeated until all carbon from PFAS are eventually stripped off to inorganic CO₂, H⁺, and F⁻.

### Photochemical

In accordance with one or more embodiments, a PFAS elimination stage may include photochemical treatment of the PFAS. For example, ultraviolet (UV) treatment has shown to be effective in the destruction of PFAS. UV treatment generally utilizes UV activation of an oxidizing salt for the elimination of various organic species. Any strong oxidant may be used. In some non-limiting embodiments, a persulfate compound may be used. In at least some embodiments, ammonium persulfate, sodium persulfate, and/or potassium persulfate may be used. Other strong oxidants, e.g., ozone or hydrogen peroxide, may also be used. The source of contaminated water may be dosed with the oxidant.

In accordance with one or more embodiments, the source of contaminated water dosed with an oxidant may be exposed to a source of UV light. For instance, the systems and methods disclosed herein may include the use of one or more UV lamps, each emitting light at a desired wavelength in the UV range of the electromagnetic spectrum. For instance, according to some embodiments, the UV lamp may have a wavelength ranging from about 180 to about 280 nm, and in some embodiments, may have a wavelength ranging from about 185 nm to about 254 nm. According to various aspects, the combination of persulfate with UV light is more effective than using either component on its own.

UV treatments to remove organic compounds are commonly known, including the VANOX® AOP system commercially available from Evoqua Water Technologies LLC (Pittsburgh, Pa.), which may be implemented. Some related patents and patent application publications are hereby incorporated herein by reference in their entireties for all purposes include: U.S. Pat. Nos. 8,591,730; 8,652,336; 8,961,798; US 2016/02077813; US 2018/0273412; and PCT/US2019/051861, all to Evoqua Water Technologies LLC.

### Plasma

In accordance with one or more embodiments, a PFAS elimination stage may include a plasma treatment. Plasmas are typically produced using a low- or ambient pressure high voltage discharge in the presence of a gas or mixture of gases, to produce free electrons, partially ionized gas ions, and fully ionized gas ions. The free electrons and ionic species, in an aquatic environment may cause the degradation of PFAS and other organic matter in a sample of contaminated water. Destruction of PFAS by plasma has been demonstrated and evidenced in the literature. Reports have shown electrons produced by plasma may be primarily responsible for degrading PFAS while the secondary oxidative species generated by plasma, such as hydroxyl radicals, play an insignificant role in initiating the reaction.

In accordance with one or more embodiments, one or more sensors may measure a level of PFAS upstream and/or downstream of the PFAS elimination stage. A controller may receive input from the sensor(s) in order to monitor PFAS levels, intermittently or continuously. Monitoring may be in real-time or with lag, either onsite or remotely. A detected PFAS level may be compared to a threshold level that may be considered unacceptable, such as may be dictated by a controlling regulatory body. Additional properties such as pH, flow rate, voltage, temperature, and other concentrations may be monitored by various interconnected or interrelational sensors throughout the system. The controller may send one or more control signals to adjust various operational parameters, i.e., applied voltage, in response to sensor input.

In accordance with another aspect, there is provided a method of treating water contaminated with PFAS. The method may comprise introducing contaminated water from a source of water contaminated with a first concentration of PFAS to an inlet of a PFAS separation stage and treating the contaminated water in the PFAS separation stage to produce a product water substantially free of PFAS and a PFAS concentrate having a second PFAS concentration greater than the first PFAS concentration. The method may further comprise introducing the PFAS concentrate to an inlet of a PFAS elimination stage and activating the PFAS elimination stage to eliminate the PFAS in the PFAS concentrate. The elimination rate of PFAS may be greater than about 99%. The elimination of PFAS occurs onsite with respect to the source of contaminated water.

In some embodiments, the method of treating water contaminated with PFAS may include treating the PFAS concentrate from the PFAS separation stage to produce a concentrate having a third concentration of PFAS, the third PFAS concentration greater than the second PFAS concentration. The method of treating water contaminated with PFAS may further include introducing the concentrate having the third concentration of PFAS to the inlet of the PFAS elimination stage. In some cases, process conditions, such as pressure, temperature, pH, concentration, flow rate, or TOC level in the source water and/or product water are monitored during treatment.

In accordance with another aspect, there is provided a method of method of retrofitting a water treatment system as described herein. The method may comprise providing a PFAS elimination module and fluidly connecting the PFAS elimination module downstream of a PFAS separation stage. The PFAS separation stage and/or the PFAS elimination stage may be the PFAS separation stage and/or the PFAS elimination stage as described herein, for example, a PFAS separation stage comprising ion exchange, nanofiltration, or adsorption onto electrochemically active substrates and/or a PFAS elimination stage comprising an electrochemical cell, UV-persulfate treatment, or plasma treatment.

### EXAMPLES

The function and advantages of these and other embodiments can be better understood from the following examples. These examples are intended to be illustrative in nature and are not considered to be limiting the scope of the invention.

### Example 1

In this example, the benefits of non-direct electrochemical treatment for PFAS elimination, rather than directly electrochemically treating the PFAS contaminated water as it enters a water treatment system, are discussed. A first reason for non-direct electrochemical treatment for PFAS elimination is reducing the energy expenditure needed to drive the reactions. Generally, organic species removal by electrochemical oxidation at low concentration (usually less than 100 ppm) follows an exponential relationship with energy input. In this region, reactions on anode surfaces are limited by mass transport of species to the reaction site rather than being dependent on anodic current. Therefore, the EEO (Energy Expense per Order) is usually applied to describe energy efficiency of an electrochemical PFAS elimination system instead of energy expense per weight or per mole of contaminants that are eliminated.

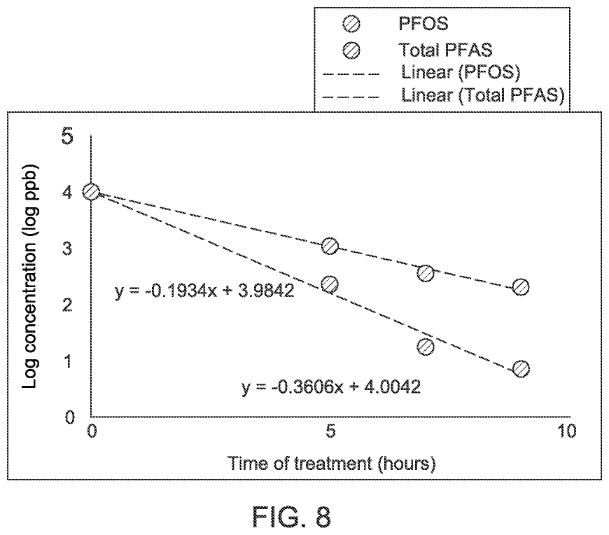

As shown in FIG. 8, generated from the LC/MS/MS measured PFAS concentrations shown in Table 2 below, the time necessary to decrease the concentration of PFAS, in particular PFOS, by an order of magnitude has a non-linear dependence. Specifically referring to the data of FIG. 8, to reduce PFOS or total PFAS from water by one order, 2.77 or 5.17 hours of treatment shall be applied, respectively, on a well-determined BDD module and process flow, noting that the time to reduce PFOS or total PFAS from water varies with different module designs, process flow conditions, water matrix, and the volume of effluent to treat, among other factors.

TABLE 2
Elapsed Time for PFAS Elimination Using an Electrochemical PFAS Elimination
Stage with a BDD Electrode

| | Treatment | | | | | | | | | | | | | |
|---|---|---|---|---|---|---|---|---|---|---|---|---|---|---|
| | Time | | | | | | | | | | | | | Total PFAS |
| Sample Name | (hours) | PF4A | PF5A | PF6A | PF7A | PFOA | PF4S | PF5S | PF6S | PF7S | PF8S | PF9S | PF10S | remaining |
| BDD-PFOS | 0 | | | | | | | | | | 10000 | | | 10000.00 |
| from 10000 ppb | 5 | 125.4 | 115.6 | 111.6 | 100 | 48.4 | 0 | 14.06 | 250 | 66.4 | 216 | 0 | 0 | 1047.46 |
| | 7 | 85.4 | 70.2 | 58.8 | 39.6 | 10.62 | 0 | 5.68 | 61.8 | 7.7 | 17.06 | 0 | 0 | 356.86 |
| | 9 | 66 | 49.1 | 34.5 | 16.4 | 5.03 | 0 | 2.65 | 17.4 | 1.71 | 7.54 | 0 | 0 | 200.33 |

Consider source water of a volume Q m³ containing C ppb PFAS for treatment: in order to reduce total PFAS to the U.S. EPA's guideline of 70 ppt, PFAS removal on the order of (logC+1.155) is required.

Energy consumption for total PFAS removal directly by electrochemical PFAS elimination in the same process configuration of FIG. 8 shall be described as below:

E(source PFAS destruct.)=α×I×V×5.17×(log C+1.155)×Q (1)

where α is a process constant, I is current, and V is cell voltage.

However, if a combined process is applied together with electrochemical PFAS elimination to concentrate the PFAS by 10^{b} time the original PFAS concentration via ion exchange or other technologies as described herein, the energy consumption for total PFAS removal will be:

E(conc. PFAS destruct.)=α×I×V×5.17×[(log(C×10^{b})+1.155]×Q/10^{b} (2)

Combining (1) and (2) above:

$$E ( source PFAS destruct . ) = E ( conc . PFAS destruct . ) \frac{( log C + 1.155 ) 1 {0}^{b}}{Log C + 1.155 + b} \qquad ( 3 )$$

Consider a raw water of 1000 ppt PFAS and a desired PFAS concentration enhancement of 10⁴:

E(source PFAS destruct.)=E(conc. PFAS destruct.)×2241 (4)

It is worth noting that the estimation above does not consider energy expense in the process of concentrating PFAS by various technologies (defined as E(concentration) thereafter); however, the energy necessary to achieve this is significantly lower than direct electrochemical oxidation from raw water. A very conservative ratio between E(source PFAS destruct.) and E(conc. PFAS destruct.) is 10 when 1000 ppt PFAS in source water was treated.

Therefore, the total energy expense for a process combing concentrating PFAS and elimination by BDD to treat 1000 ppt PFAS from (4) shall be modified to be:

$$E ( conc . PFAS destruct . ) = \frac{E ( source PFAS destruct . )}{2241} + \frac{E ( source PFAS destruct . )}{10} \approx \frac{E ( source PFAS destruct . )}{10} \qquad ( 5 )$$

In addition, significant extra capital cost will be a concern for direct oxidation treatment on raw water since treatment by a constrained period is usually required in industrial applications while the capacity of BDD is still limited by the technology. Comparison of module input is shown in (6):

$$BDD ( modules , by source PFAS destruct . ) = \frac{log C + 1.155}{log C + b + 1.155} \times 1 {0}^{b} BDD ( modules , by conc . PFAS destruct . ) \qquad ( 6 )$$

Therefore, for the same raw water having 1000 ppt PFAS and a 10⁴ concentration enhancement, the number of BDD modules required to treat the source water directly would be 2241 times that of the number of BDD modules in a constrained fixed time of period. This cost would be very concerning, as commercial BDD modules may be cost-prohibitive.

A second reason is to control by-products resulting from the oxidation of chloride ions in the matrix of the source of contaminated water. Source water for direct electrochemical oxidation will inevitably produce chlorine, chlorate, and even perchlorate on BDD anodes. Even though organic chlorine disinfection by-products (e.g., trihalomethanes (THMs)) would tend to be eliminated by inert anodes, inorganic chlorine compounds including chlorine, chlorate and perchlorate would remain and keep accumulating during the treatment in the batch process. However, in a process combining PFAS concentrating procedures and BDD elimination as described herein, the source water matrix is well-controlled, and the production of chloride by-products is substantially mitigated.

Table 3 shows collected data for free chlorine, chlorate, and perchlorate concentrations of a source water containing 500 ppm NaCl and 500 ppb PFOA after treatment by BDD anodes. The reaction was manually stopped, and chlorine species were analyzed when 500 ppb PFOA was decreased to 20 ppb as detected by ion chromatography coupled with a PROTOSIL HPLC column where a solution of 10 mM boric acid and 10% acetonitrile (adjusted to pH 8) was employed as the mobile phase. Measurement of free chlorine was achieved by an iodometric titration method while chlorate and perchlorate were measured by ion chromatography employing a METROSEP A Supp 5 anion exchange column where a solution of carbonate and bicarbonate was used as the mobile phase.

TABLE 3
Inorganic chlorine contaminants present after electrochemical
PFAS elimination using a BDD electrode.

| Chlorine Species | Concentration (ppm) |
|---|---|
| Free chlorine (as NaClO) | 58 |
| Chlorate (ClO₃⁻) | 115 |
| Perchlorate (ClO₄⁻) | 2.3 |

### Example 2

FIG. 1 provides a schematic of a water treatment system including one or more anion exchange vessels for the removal of PFAS from a source of contaminated water and electrochemical elimination of the separated PFAS. The source of contaminated water has a PFAS concentration of 0.1-100 ppb that is directed to the inlet of one of the one or more anion exchange vessels to allow the PFAS in the water to adsorb onto the anion exchange resin. The treated water exiting the one or more anion exchange vessels does not have a detectable concentration of PFAS. After a predetermined period of time, the adsorbed PFAS are removed from the anion exchange resin by flushing the anion exchange vessel with a regeneration solution consisting of 50-70% methanol, 30-50% water, and 0.5-1.0% NaOH. The PFAS-loaded regeneration solution exits the anion exchange vessel and has a PFAS concentration of 0.05-50 mg/L.

To facilitate electrochemical PFAS elimination and recover methanol from the regeneration solution for reuse, the methanol is thermally removed from the PFAS-loaded regeneration solution, removing 50-70% of the total volume of the regeneration solution and leaving behind water and 1-2% NaOH. The collected methanol is fed back to the anion exchange regeneration solution as makeup flow during the anion exchange regeneration process. After the methanol has been removed from the PFAS-loaded regeneration solution, the PFAS concentration in the now-concentrated regeneration solution is 0.1-100 mg/L. The

PFAS-enriched regeneration solution is introduced into an electrochemical PFAS elimination stage, where the PFAS are electrochemically oxidized until none remain. The treated water from the electrochemical PFAS elimination has the remaining 1-2% NaOH neutralized, and the resulting neutralized water is discharged as treated water with no detectable PFAS concentration. The water treatment system of this example is effective if the PFAS compounds in the source of contaminated water were oxidized to near completion.

### Example 3

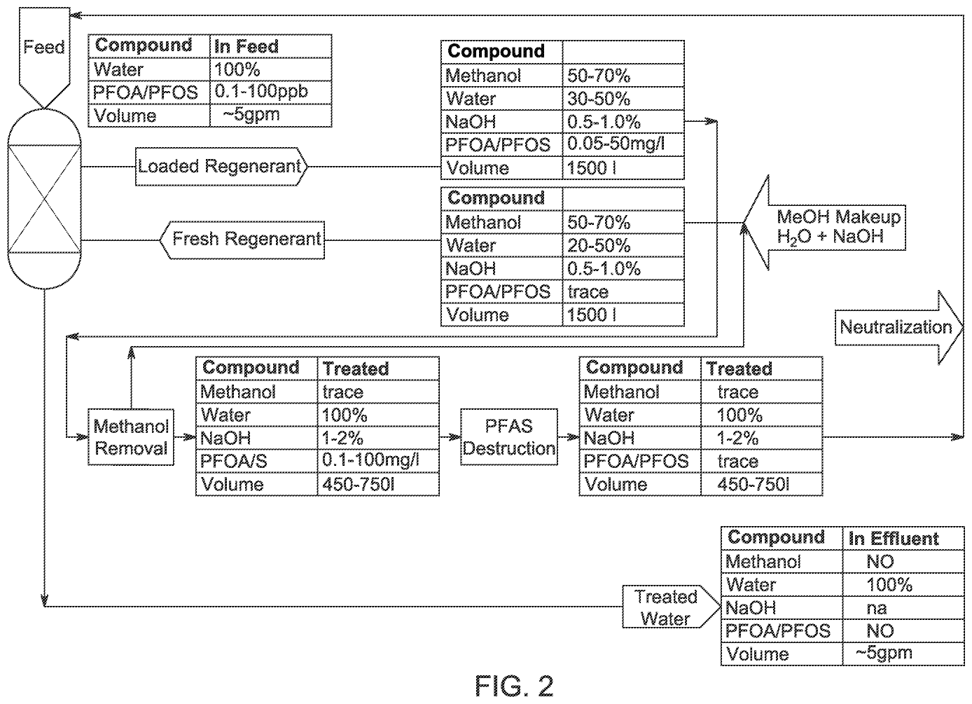

FIG. 2 provides a schematic of a water treatment system including one or more anion exchange vessels for the removal of PFAS from a source of contaminated water and electrochemical elimination of the separated PFAS. The source of contaminated water has a PFAS concentration of 0.1-100 ppb that is directed to the inlet of the one or more anion exchange vessels to allow the PFAS in the water to adsorb onto the anion exchange resin. The treated water exiting the one or more anion exchange vessels does not have a detectable concentration of PFAS. After a predetermined period of time, the adsorbed PFAS are removed from the anion exchange resin by flushing the anion exchange vessel with a regeneration solution consisting of 50-70% methanol, 30-50% water, and 0.5-1.0% NaOH. The PFAS-loaded regeneration solution exits the one or more anion exchange vessels having a PFAS concentration of 0.05-50 mg/L.

To facilitate electrochemical PFAS elimination and recover methanol from the regeneration solution for reuse, the methanol is thermally removed from the PFAS-loaded regeneration solution, removing 50-70% of the total volume of the regeneration solution and leaving behind water and 1-2% NaOH. The collected methanol is fed back to the anion exchange regeneration solution as makeup flow during the anion exchange regeneration process. After the methanol has been removed from the PFAS-loaded regeneration solution, the PFAS concentration in the now-concentrated regeneration solution is 0.1-100 mg/L. The PFAS-enriched regeneration solution is introduced into an electrochemical PFAS elimination stage, where the PFAS are electrochemically oxidized to reduce the concentration of PFAS in the enriched PFAS-loaded regeneration solution. In this example, the electrochemical PFAS elimination did not fully eliminate all PFAS from the enriched PFAS-loaded regeneration solution; the PFAS concentration after electrochemical PFAS elimination is 0.005-5 mg/L. The resulting solution from the incomplete electrochemical PFAS elimination has the 1-2% NaOH remaining neutralized and is fed back into the inlet of one of the one or more anion exchange vessels of the PFAS separation stage to continue the PFAS separation process.

### Example 4

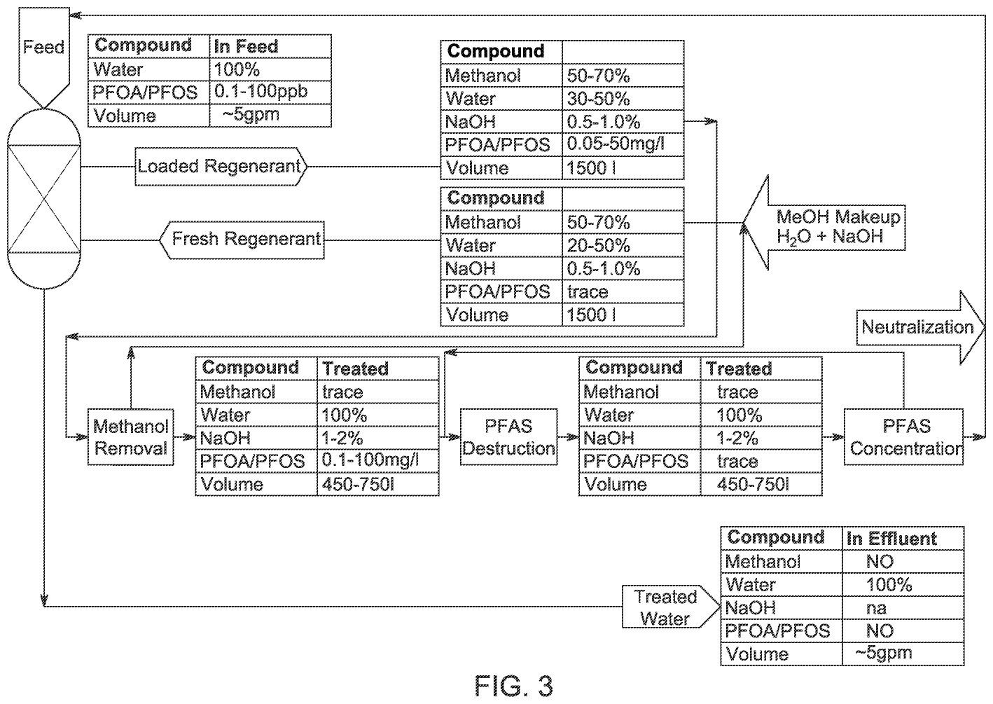

FIG. 3 provides a schematic of a water treatment system including one or more anion exchange vessels for the removal of PFAS from a source of contaminated water and electrochemical elimination of the separated PFAS. The source of contaminated water has a

PFAS concentration of 0.1-100 ppb that is directed to the inlet of one of the one or more anion exchange vessels to allow the PFAS in the water to adsorb onto the anion exchange resin. The treated water exiting the anion exchange vessel does not have a detectable concentration of PFAS. After a predetermined period of time, the adsorbed PFAS are removed from the anion exchange resin by flushing the anion exchange vessel with a regeneration solution consisting of 50-70% methanol, 30-50% water, and 0.5-1.0% NaOH. The PFAS-loaded regeneration solution exits the anion exchange vessel and has a PFAS concentration of 0.05-50 mg/L.

To facilitate electrochemical PFAS elimination and recover methanol from the regeneration solution for reuse, the methanol is thermally removed from the PFAS-loaded regeneration solution, removing 50-70% of the total volume of the regeneration solution and leaving behind water and 1-2% NaOH. The collected methanol is fed back to the anion exchange regeneration solution as makeup flow during the anion exchange regeneration process. After the methanol has been removed from the PFAS-loaded regeneration solution, the PFAS concentration in the now-concentrated regeneration solution is 0.1-100 mg/L. The PFAS-enriched regeneration solution is introduced into an electrochemical PFAS elimination stage, where the PFAS are electrochemically oxidized to reduce the concentration of PFAS in the enriched PFAS-loaded regeneration solution. In this example, it was found that the electrochemical elimination of PFAS did not oxidize the PFAS to near completion, indicating that short chain PFAS remain in the solution after a first pass of electrochemical elimination. This solution may have the remaining short chain PFAS concentrated using a membrane concentrator, such as a nanofiltration stage, to produce a concentrate solution enriched in the remaining short chain PFAS. This enriched solution is fed back into the electrochemical PFAS elimination stage, thus facilitating the complete oxidation of the remaining short chain PFAS. Alternatively, if the electrochemical elimination of the PFAS was close to complete, the resulting solution from the electrochemical PFAS elimination has the 1-2% NaOH remaining neutralized and is fed back into the inlet of one of the one or more anion exchange vessels of the PFAS separation stage to continue the PFAS separation process.

### Example 5

FIG. 4 provides a schematic of a water treatment system including a nanofiltration PFAS separation stage. The nanofiltration PFAS separation stage can include one or more nanofiltration units, and the number and type of nanofiltration units will depend of the water matrix of the source of water contaminated with PFAS. The water contaminated with PFAS is directed to the inlet of the one or more nanofiltration units. The permeate from the one or more nanofiltration units is discharged as treated water substantially free of PFAS. The concentrate from the one or more nanofiltration units is enriched in PFAS. This PFAS enriched concentrate is optionally directed to the inlet of a hardness removal unit should a concern exist that the concentrate has an enriched concentration in ions that may foul any additional membranes in the water treatment system or may cause scale formation on downstream process equipment. Either after passing through the hardness removal stage or coming direct from the concentrate outlet of the nanofiltration PFAS separation stage, the PFAS enriched concentrate is directed to the inlet of a nanofiltration diafiltration stage to further concentrate the PFAS from the original enriched PFAS concentrate and remove chloride salts from the permeate solution. The nanofiltration diafiltration concentration step requires the use of a water supply that has low TSS, such as the diluate from a RO or electrodialysis (ED) unit, as makeup water to ensure that salts are washed out and PFAS are enriched in the resulting concentrate. The further PFAS-enriched concentrate is introduced into an electrochemical PFAS elimination stage, where the PFAS are electrochemically oxidized until none remain. The treated water from the electrochemical PFAS elimination is directed back to the first PFAS separation stage and is combined with the treated water from said first PFAS separation stage and discharged as treated water.

### Example 6

FIG. 5 provides a schematic of a water treatment system including one or more nanofiltration units for the removal of PFAS from a source of contaminated water and electrochemical elimination of the separated PFAS. The source of contaminated water has a PFAS concentration of 0.1-100 ppb and a NaCl concentration of 100-300 ppm; this feed is directed to the inlet of a TSS removal stage configured to reduce clogging and fouling on the membranes of the one or more nanofiltration units. The diluate from the TSS removal stage is directed to one of the one or more nanofiltration units to allow the PFAS in the water to be trapped by the membranes and collected as the concentrate from the one or more nanofiltration units. The treated water exiting the one or more nanofiltration units has a concentration of PFAS less that the current U.S. EPA lifetime exposure limit of 70 ppt. The concentrate from the one or more nanofiltration units has a PFAS concentration of 0.01-10 ppm, a Ca/Mg ion concentration on the order to >100 ppm, and a NaCl concentration of >1000 ppm. To facilitate electrochemical PFAS elimination, the concentrate from the one or more nanofiltration units is directed to the inlet of a hardness removal stage to decrease the concentration of Ca/Mg ions from the concentrate by chemical precipitation. The resulting PFAS-enriched concentrate, now having a Ca/Mg concentration of <10 ppm, is directed from the outlet of the hardness removal stage to a storage tank, where it is used as the feed water of a nanofiltration diafiltration stage to further concentrate the PFAS from the original enriched PFAS concentrate and remove chloride salts from the permeate solution. To dilute the concentration of salts prior to nanofiltration diafiltration, water that originates from a source of water with a low TSS concentration, such as from a RO or ED unit, is added to the storage tank holding the PFAS-enriched concentrate. The diluate that results from the nanofiltration diafiltration stage is added to the discharge from the PFAS separation stage as discharge. After reducing the chloride salt concentration to about <100 ppm and increasing the PFAS concentration to 1-1000 ppm, the further PFAS-enriched concentrate is introduced into an electrochemical PFAS elimination stage, where the PFAS are electrochemically oxidized until less than 10 ppb PFAS remain. The treated water from the electrochemical PFAS elimination is directed back to the first PFAS separation stage and is blended with the treated water from said first PFAS separation stage and discharged as treated water, where the discharged water has a PFAS concentration of <70 ppt and a chloride salt content of 100-300 ppm.

### Example 7

A GAC electrode (1.7 g electrode material in total including 80% by weight GAC, 10% by weight graphite as the conductor and 10% by weight high molecular weight polyethylene (PE) as the binder) was used to adsorb PFOA of 1 ppm in 1 liter of water. 65% of the initial 1 ppm PFOA was adsorbed onto the GAC as measured by ion chromatography coupled with a PROTOSIL HPLC column using a solution of 10 mM boric acid and 10% acetonitrile (adjusted to pH 8) as the mobile phase. The GAC electrode was then regenerated in 25 mL of a Na₂SO₄ salted deionized (DI) solution when 20 mA DC current was applied in an electrochemical cell with a platinum coated titanium electrode employed as the anode. After 1 hour of electrochemical separation, 0.68 ppm PFOA was detected in the concentrate solution, corresponding to 2.6% recovery rate.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. An onsite system for treating a source of water contaminated with perfluoro alkyl substances (PFAS), comprising:
a PFAS separation stage having an inlet fluidly connectable to the source of water contaminated with PFAS, a diluate outlet, and a concentrate outlet; and
a PFAS elimination stage positioned downstream of the PFAS separation stage and having an inlet fluidly connected to an outlet of the PFAS separation stage, the elimination of the PFAS occurring onsite with respect to the source of water contaminated with PFAS, the system being configured to maintain an overall elimination rate of PFAS greater than about 99%.

2. The system of claim 1, wherein the system maintains a concentration of PFAS in the diluate of the PFAS separation stage below a predetermined threshold.

3. The system of claim 2, wherein the predetermined threshold is less than 70 parts per trillion (ppt).

4. The system of claim 3, wherein the predetermined threshold is less than 12 ppt.

5. The system of claim 1, further comprising a hardness removal stage.

6. The system of claim 1, further comprising a control system configured to regulate the feed directed between the PFAS separation stage and the PFAS elimination stage.

7. The system of claim 6, further comprising a PFAS sensor positioned downstream of the diluate outlet of the PFAS separation stage.

8. The system of claim 1, wherein the PFAS separation stage comprises one or more ion exchange modules.

9. The system of claim 8, further comprising regeneration of the ion exchange modules to remove bound PFAS to produce a PFAS concentrate.

10. The system of claim 9, wherein the regeneration comprises contacting the ion exchange modules with a regeneration solution comprising methanol, water, and NaOH.

11. The system of claim 1, wherein the PFAS separation stage comprises one or more nanofiltration modules.

12. The system of claim 11, wherein a concentrate comprising PFAS from the one or more nanofiltration modules has its PFAS concentration increased by passing through one or more nanofiltration diafiltration modules downstream of the one or more nanofiltration modules.

13. The system of claim 12, wherein the one or more nanofiltration diafiltration modules target removal of NaCl and/or KCl.

14. The system of claim 1, wherein the PFAS separation stage involves adsorption onto an electrochemically active substrate.

15. The system of claim 14, wherein the electrochemically active substrate comprises granular activated carbon (GAC).

16. The system of claim 15, wherein the GAC comprises an electrode in an electrochemical cell.

17. The system of claim 16, wherein an electrode in the electrochemical cell comprises platinum, a mixed metal oxide (MMO) coated dimensionally stable anode (DSA) material, graphite, or lead/lead oxide.

18. The system of claim 16, wherein the electrochemical cell further comprises a sulfate electrolyte.

19. The system of claim 16, further comprising an ion exchange membrane separator.

20. The system of claim 16, wherein the adsorbed PFAS are desorbed from the electrochemically active substrate by electrical activation of the electrochemical cell.

21. The system of claim 1, wherein the PFAS separation stage involves foam fractionation.

22. The system of claim 1, wherein the PFAS elimination stage comprises an electrochemical PFAS elimination stage.

23-57. (canceled)
